(19) United States
(12) Patent Application Publication
(10) Pub. No.: US 2010/0252546 A1
(43) Pub. Date: Oct. 7, 2010

(54) METHOD FOR OPERATING AN IGNITION DEVICE

(76) Inventors: Werner Herden, Gerlingen (DE); Martin Weinrotter, Stuttgart-Botnang (DE); Pascal Woerner, Stuttgart (DE); Manfred Vogel, Ditzingen (DE); Juergen Raimann, Weil Der Stadt (DE); Bernd Schmidtke, Leonberg (DE); Heiko Ridderbusch, Schwieberdingen (DE)

Correspondence Address: KENYON & KENYON LLP, ONE BROADWAY, NEW YORK, NY, 10004, US

(21) Appl. No.: 12/733,498

(22) PCT Filed: Aug. 22, 2008
(86) PCT No.: PCT/EP2008/060993

§ 371 Date: Jun. 1, 2010

(30) Foreign Application Priority Data
Sep. 10, 2007 (DE) 10 2007 043 115.7

(51) Int. Cl. B60L 1/02; F02B 19/00

(52) U.S. Cl. 219/205; 123/143 B

(57) ABSTRACT

A method is described for operating an ignition device, in particular in an internal combustion engine, having a combustion chamber window for optically connecting the ignition device to a combustion chamber. An optical signal which may be detected in the region of the combustion chamber window is evaluated to deduce a state of the combustion chamber window. In particular, soiling of the combustion chamber window may be identified in this manner.

### BACKGROUND OF THE INVENTION

1. Field of the Invention

The present invention relates to a method for operating an ignition device, in particular in an internal combustion engine, having a combustion chamber window for optically connecting the ignition device to a combustion chamber.

The present invention further relates to a corresponding ignition device.

2. Description of Related Art

Such operating methods and ignition devices are known. It is disadvantageous that over a period of use of the ignition device the optical characteristics of the combustion chamber window may be impaired, for example because of deposits which collect in particular on a surface of the combustion chamber window on the combustion chamber side.

In particular, transmission of optical radiation to be introduced through the combustion chamber window into the combustion chamber and/or radiation originating from the combustion chamber, for example radiation to be analyzed, may be impaired by the above-described soiling effects, so that reliable operation of the ignition device is no longer possible.

### SUMMARY OF THE INVENTION

Accordingly, the object of the present invention is to improve an operating method for an ignition device, and an ignition device of the aforementioned type, in such a way that reliable operation is provided over a fairly long period of use, in particular when soiling of the combustion chamber window also occurs.

For a method of the aforementioned type, this object is achieved according to the present invention by the fact that an optical signal which may be detected in the region of the combustion chamber window is evaluated to deduce a state of the combustion chamber window.

According to the present invention it has been recognized that the analysis of optical signals occurring in the region of the combustion chamber window provides information not only concerning combustion processes taking place in the combustion chamber, but also concerning a state of the combustion chamber window.

Accordingly, the evaluation of such optical signals according to the present invention advantageously allows conclusions to be drawn in particular about a degree of soiling of the combustion chamber window, as well as other possibly occurring effects which may impair operation of the ignition device. According to the present invention, the evaluation results may advantageously be used to modify operation of the ignition device for the particular operating state, in particular the soiling state of the combustion chamber window, thus ensuring reliable operation of the ignition device over a fairly long period of use.

One particularly advantageous specific embodiment of the method according to the present invention provides that the ignition device has a laser device via which a laser pulse is emitted through the combustion chamber window and into the combustion chamber. Use of this type of laser-based ignition device in conjunction with the operating method according to the present invention offers a number of synergistic effects. On the one hand, the laser-based ignition device may advantageously be used to generate a test radiation which allows the combustion chamber window to be investigated according to the present invention by evaluating components of the test radiation which interact with the combustion chamber window as an optical signal in the sense of the present invention. A pumped light source which is present anyway for the laser-based ignition device may be used to provide the test radiation in an extremely advantageous manner.

For a corresponding soiling state it is also advantageously possible to clean the combustion chamber window by generating high-energy laser pulses using the laser-based ignition device.

As an alternative or in addition to a laser device, a separate test radiation source may be provided which acts upon the combustion chamber window with test radiation. This variant of the present invention advantageously allows the use of the evaluation methods according to the present invention, also in conjunction with ignition devices which have no laser system.

A further advantageous variant of the method according to the present invention provides that radiation emitted by an ignition plasma is evaluated as an optical signal. In this method variant a reference signal may advantageously be ascertained, for example by evaluating the radiation or the intensity of the radiation, emitted by the ignition plasma in a new state of the ignition device or of the combustion chamber window. From that time on, the optical signal ascertained during further operation of the ignition device may be correlated with the reference signal, so that the corresponding relationship quantifies a soiling state of the combustion chamber window.

As an alternative or in addition to the evaluation of the radiation emitted by the ignition plasma, radiation emitted by a flame core in the combustion chamber may also be used.

As the result of a further very advantageous variant of the present invention, the optical signal may also be used to characterize the flame core, so that in addition to obtaining information concerning a state of the combustion chamber window, at the same time it is also possible to analyze combustion processes taking place in the combustion chamber.

As the result of a further variant of the present invention, particularly precise information concerning a soiling state of the combustion chamber window is obtained by evaluating radiation scattered on the combustion chamber window and/or on deposits present on a surface of the combustion chamber window as an optical signal. The scattered radiation may be provided in a laser-based ignition device or as the result of the combustion chamber window being acted upon by a laser pulse used as an ignition pulse, so that the combustion chamber window does not have to be acted upon separately by test radiation for the evaluation according to the present invention.

Alternatively, a separate test radiation source may be provided for this purpose which generates test radiation, in particular outside activation times of an optionally present laser-based ignition device, to allow the evaluation according to the present invention. Instead of the ignition pulses used for igniting an air/fuel mixture provided in the combustion chamber, additional laser pulses may also be generated by a laser-based ignition device which may be used as test radiation, and which preferably are emitted outside the activation time ranges provided for the ignition pulses.

In a further extremely advantageous variant of the operating method according to the present invention, it is provided that the test radiation is selected, in particular with regard to its intensity, in such a way that the deposits present on a surface of the combustion chamber window are converted, at least partially, into a plasma, and that radiation emitted by this plasma is evaluated as an optical signal. The plasma originating from the deposits has characteristic emission spectra of the compounds which form the soiling on the combustion chamber window, which are usually different from the wavelengths used for a laser-based ignition device, and which are usually also different from the wavelengths emitted by the ignition plasma, so that these emission spectra may accordingly be easily analyzed within the scope of the method according to the present invention, thus allowing identification of even individual chemical compounds contributing to the soiling of the combustion chamber window. Test radiation having such an intensity may at the same time be advantageously used for cleaning the combustion chamber window.

In a further very advantageous variant of the method according to the present invention, it is provided that the combustion chamber is acted upon by test radiation, preferably through the combustion chamber window, and that a radiation component of the test radiation reflected on a component of the combustion chamber, in particular on a piston crown of a piston associated with the combustion chamber, is evaluated as an optical signal.

In this variant of the present invention, the test radiation preferably has a relatively low intensity to prevent undesired formation of an ignition plasma in the combustion chamber. The reflected radiation component of the test radiation of interest may be optically separated from other signals, for example, by providing the reflective component of the combustion chamber with a fluorescent layer which transforms the wavelength of the test radiation. Propagation time filtering of the reflected test radiation is also possible.

A further very advantageous variant according to the present invention provides that the combustion chamber window is acted upon by emitted test radiation at a specifiable angle, it also being possible in particular to provide test radiation which is emitted essentially perpendicular to the combustion chamber window or the surface thereof.

In order to separate the reflected components of the test radiation from other radiation components, when the combustion chamber window is acted upon perpendicularly, in particular radiation components of the test radiation reflected from objects other than the combustion chamber window, according to the present invention propagation time filtering of the reflected radiation components of the test radiation of interest, which is possible due to the known geometry of the ignition device and thus, the length of the corresponding optical paths, may advantageously be carried out.

A higher time resolution may advantageously be achieved in the propagation time filtering according to the present invention by providing a folded beam path, in particular multiply folded beam paths, for the test radiation. Alternatively or additionally, an optical retarder may be provided in the beam path.

In general, a soiling state of the combustion chamber window and/or damage thereto may be deduced from a comparison of the optical signal evaluated according to the present invention, obtained after a certain period of use of the ignition device, to a corresponding optical signal obtained with a new/cleaned system. As the result of a further variant of the present invention, this information ascertained according to the present invention may advantageously be used to prompt for maintenance of the ignition device and/or cleaning of the combustion chamber window, which may be achieved, for example, by applying a corresponding error entry in an error memory of a control unit which controls the ignition device.

A further advantageous method variant provides for cleaning of the combustion chamber window as a function of the evaluation of the optical signal, which may be carried out in conjunction with a laser-based ignition system, in particular by acting upon the combustion chamber window using high-energy laser pulses. It is extremely advantageous that in this method variant there is no need to perform manual maintenance on the ignition device.

For only minor soiling of the combustion chamber window, it is advantageous that only relatively few high-energy laser pulses are emitted for cleaning the combustion chamber window in order to spare the laser system of the ignition device, in particular a pumped light source provided therein. For example, it is possible for the high-energy laser pulses to be emitted only every n working cycles of the internal combustion engine, where n>1.

In another very advantageous variant of the operating method according to the present invention, it is provided that the use of unsuitable operating materials, in particular lubricants, for a cylinder associated with the combustion chamber is deduced as a function of the evaluation of the optical signal. Such conclusions may be drawn, for example, when relatively severe soiling of the combustion chamber window occurs repeatedly after relatively short time intervals, in particular following a maintenance procedure. On the basis of the emission spectra which result when the deposits are converted to a plasma according to the present invention, conclusions may also advantageously be drawn instantaneously concerning the use of unsuitable molecules or compounds in the operating materials, so that as a function thereof an immediate shutdown of the internal combustion engine or other system responses may be initiated if necessary, in particular to prevent further possible damage from the use of incorrect or improper operating materials.

A combination of the above-described method variants according to the present invention is also possible, thus providing the possibility of even more precise analysis and/or plausibility checking of the individual evaluations.

An ignition device according to claim 15 is provided as a further approach to achieving the object of the present invention.

The principle according to the present invention may advantageously be used for internal combustion engines of motor vehicles, or also for stationary engines or gas turbines. Although a combination of the operating method according to the present invention with a laser-based ignition system is particularly advantageous due to the synergistic effects discussed above, the evaluation according to the present invention may also be advantageously used for ignition devices having a combustion chamber window which have no laser system, for example for high-voltage ignition systems, etc.

Further features, application possibilities, and advantages of the present invention result from the following description of exemplary embodiments of the present invention which are illustrated in the figures of the drawing. All described or illustrated features, alone or in any given combination, constitute the subject matter of the present invention, independently of their combination in the claims or back-reference, and independently of their wording or illustration in the description or drawing, respectively.

### BRIEF DESCRIPTION OF THE SEVERAL VIEWS OF THE DRAWINGS

FIG. 1 shows a first specific embodiment of an ignition device according to the present invention.

FIG. 2 shows a detailed view of a laser device of the ignition device according to FIG. 1.

FIGS. 3a-3g show various specific embodiments of the ignition device for use with the operating method according to the present invention.

### DETAILED DESCRIPTION OF THE INVENTION

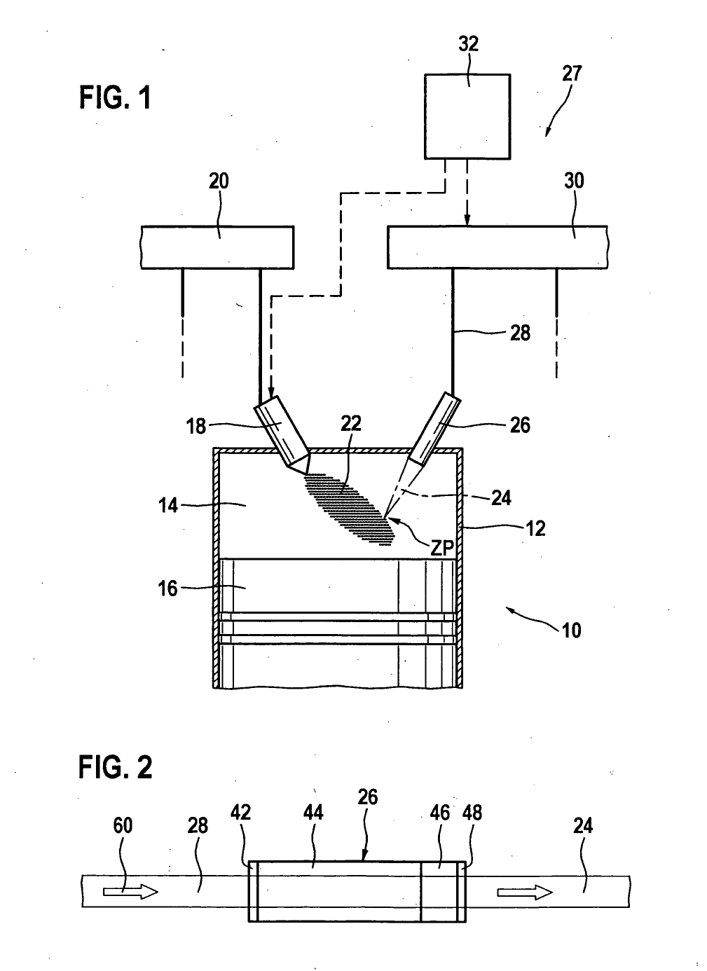

An internal combustion engine overall is denoted by reference numeral 10 in FIG. 1. The internal combustion engine is used to drive a motor vehicle, not illustrated. Internal combustion engine 10 includes multiple cylinders, of which only one is denoted by reference numeral 12 in FIG. 1. A combustion chamber 14 for cylinder 12 is delimited by a piston 16. Fuel passes directly into combustion chamber 14 via an injector 18 which is connected to a fuel pressure accumulator 20, also referred to as a rail or common rail.

In general, the mixture may also be formed outside combustion chamber 14, for example in an intake manifold (not illustrated), so that an appropriate air/fuel mixture may be supplied in a known manner to combustion chamber 14 through an intake valve (not shown).

Fuel 22 injected into combustion chamber 14 is ignited using a laser pulse 24 which is emitted into combustion chamber 14 by an ignition device 27 which includes a laser device 26. For this purpose, laser device 26 is fed via an optical fiber device 28, using pumped light which is provided by a pumped light source 30. Pumped light source 30 is controlled by a control and regulation device 32 which also activates injector 18.

Pumped light source 30 may be, for example, a semiconductor laser diode which as a function of a control current emits corresponding pumped light to laser device 26 via optical fiber device 28. Although semiconductor laser diodes and other compact pumped light sources are preferred for use in the automotive sector, in principle any type of pumped light source may be used for operating ignition device 27 according to the present invention.

FIG. 2 schematically shows a detailed view of laser device 26 from FIG. 1.

As shown in FIG. 2, laser device 26 has a laser-active solid 44, optically downstream from which a passive Q-switch 46 is provided. Laser-active solid 44, together with passive Q-switch 46 as well as input mirror 42 situated to the left of same in FIG. 2 and output mirror 48, form a laser oscillator whose oscillation response is a function of passive Q-switch 46, and which may thus be controlled, at least indirectly, in a manner known per se.

In the configuration of laser device 26 illustrated in FIG. 2, pumped light 60 is led through optical fiber device 28, previously described with reference to FIG. 1, from likewise previously described pumped light source 30 to input mirror 42. Since input mirror 42 is transparent to the wavelengths of pumped light 60, pumped light 60 penetrates laser-active solid 44, and results in a population inversion therein which is known per se.

When passive Q-switch 46 is in its base state, in which it has a relatively small transmission coefficient, laser operation is prevented in laser-active solid 44 or in solid 44, 46 delimited by input mirror 42 and output mirror 48. With increasing pumping time, however, the radiation density in laser oscillator 42, 44, 46, 48 increases, so that passive Q-switch 46 fades, i.e., assumes a larger transmission coefficient, and laser operation is able to begin.

In this manner a laser pulse 24, also referred to as giant pulse, having a relatively high peak output is generated. Laser pulse 24 is injected into combustion chamber 14 (FIG. 1) of internal combustion engine 10, optionally using a further optical fiber device, or also directly through a combustion chamber window (not illustrated in FIG. 2) of laser device 26, thus igniting fuel 22 present therein.

Instead of a passive Q-switch 46 an active Q-switch may be provided, which fades when correspondingly activated at a specifiable point in time, thus triggering laser pulse 24.

According to the present invention, an optical signal which may be detected in the region of the combustion chamber window is evaluated to deduce a state of the combustion chamber window. In this manner, it is possible to detect in particular soiling of the combustion chamber window, which occurs due to deposition of combustion products and other substances from the combustion chamber, and the operation of ignition device 27 may continuously be adapted to an instantaneous degree of soiling of the combustion chamber window, thus providing reliable operation of ignition device 27, and therefore also of internal combustion engine 10, even over a fairly long period of use. For example, the pulse energy of laser pulses 24 required for ignition may be specified as a function of the degree of soiling of the combustion chamber window ascertained according to the present invention.

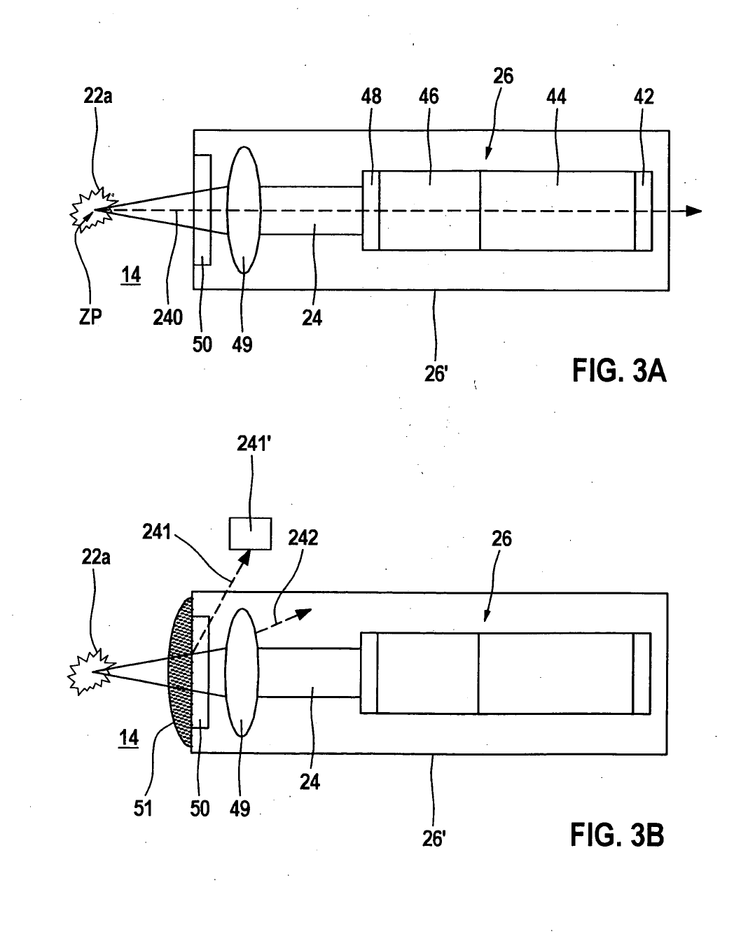

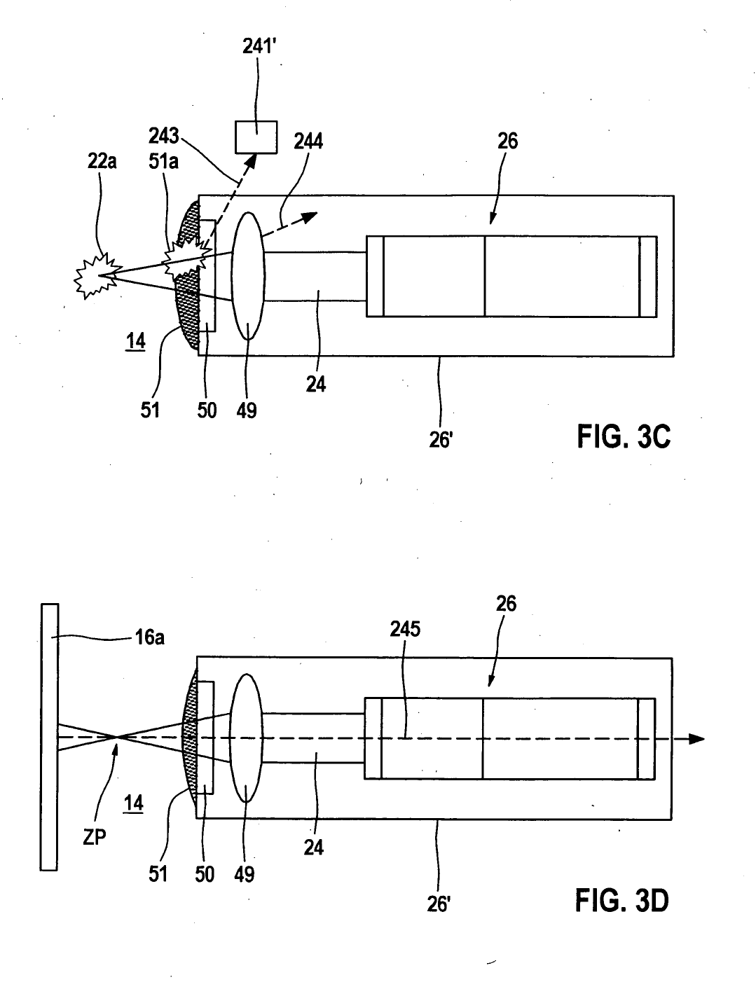

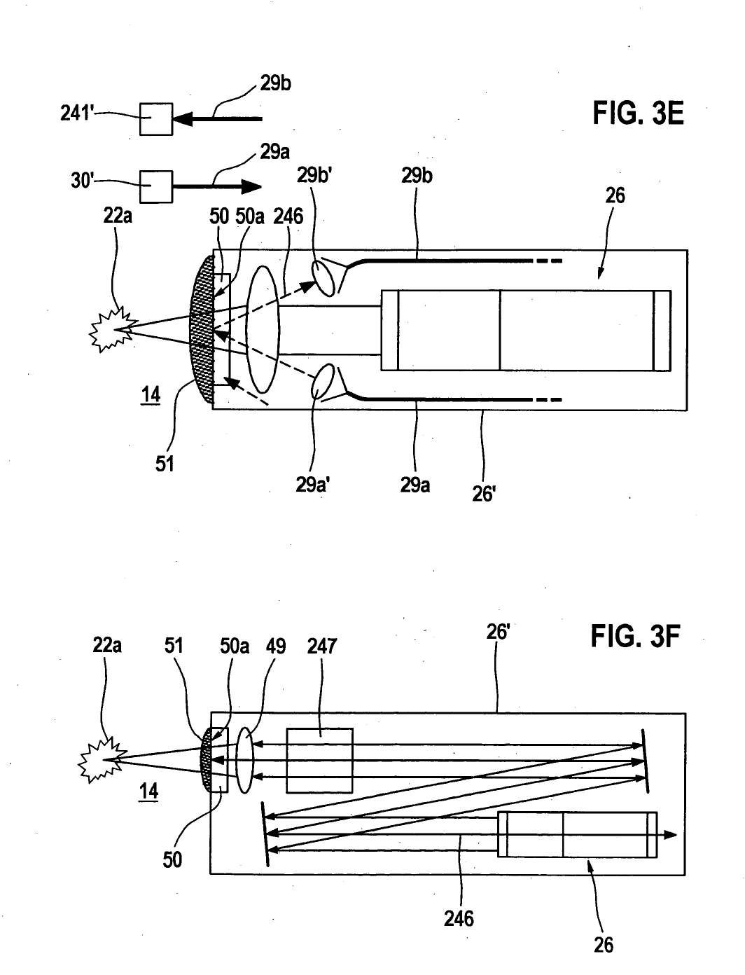

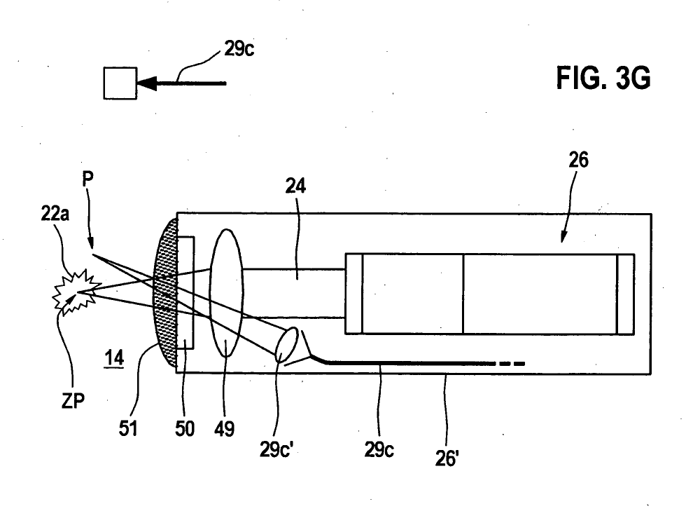

A first configuration of the ignition device for carrying out the operating method according to the present invention is illustrated in FIG. 3a.

As shown in FIG. 3a, laser pulse 24 generated by laser device 26 is focused by a focusing lens 49, indicated in FIG. 3a as a biconvex lens, and through combustion chamber window 50 situated downstream from focusing lens 49 is focused on ignition point ZP present in combustion chamber 14 (also see FIG. 1). This causes the air/fuel mixture present in combustion chamber 14 to ignite, thus forming an ignition plasma 22a in the region of ignition point ZP. Combustion chamber window 50 and focusing lens 49 may also have a monolithic, i.e., one-part, design. Such a combination is also referred to as a so-called “combustion chamber lens.” The surface geometry of at least one surface of the combustion chamber lens is selected as a function of the beam shape to be produced by the combustion chamber lens.

According to the present invention, the portion of the radiation emitted by ignition plasma 22a and which passes from combustion chamber 14 through combustion chamber window 50 and into housing 26′ of laser device 26 is used as an optical signal, on the basis of which an evaluation is carried out which allows the state of combustion chamber window 50, in particular the soiling thereof, to be deduced.

The radiation component of the radiation emitted by ignition plasma 22a which is evaluated according to the present invention is illustrated as arrow 240 in FIG. 3a. As previously described, radiation component 240 enters through combustion chamber window 50 and focusing lens 49 and through laser device 26, and is supplied to an evaluation device, not illustrated in FIG. 3a. In the present case, components 42, 44, 46, 48 of laser device 26 are transmissive for the wavelengths of radiation component 240 of interest. Otherwise, a detector (see reference numeral 241′ in the specific embodiment according to FIG. 3c) or also an optical fiber which receive radiation component 240 could be provided in the region of combustion chamber window 50. These components are preferably likewise situated in housing 26′.

As the result of one particularly advantageous variant of the present invention, the evaluation device is able to check an intensity of radiation component 240 in order to deduce therefrom, for example, the transmission characteristics of combustion chamber window 50. In particular, for a new system the intensity of radiation component 240 may be recorded as a reference signal, which in subsequent operation of ignition device 27 is compared to the intensities of radiation component 240 which are ascertained from that point on. When the soiling of combustion chamber window 50 increases, a transmission factor of combustion chamber window 50 correspondingly decreases, so that a radiation component 240 with a correspondingly reduced intensity is supplied to the evaluation device.

The intensity of radiation component 240 is subjected to approximately the same attenuation due to the soiling of the combustion chamber window 50 as is laser pulse 24, so that the pulse energy of laser pulse 24 may be modified as a function of the detected soiling in order to allow reliable ignition even for a soiled combustion chamber window 50.

When ignition device 27 is designed with a power reserve of approximately 15%, the ignition device may accordingly be operated reliably with a soiled combustion chamber window 50 until approximately 10% of the pulse energy of laser pulses 24 has been dissipated by the soiling. At that time combustion chamber window 50 must be cleaned, optionally in the course of a maintenance procedure, or self-cleaning may also be carried out by the delivery of high-energy laser pulses. In any case, the analysis according to the present invention of the state of combustion chamber window 50 allows operation of laser device 26 which is tailored to requirements and which contributes to increased service life of the laser device and energy savings.

FIG. 3b shows a further advantageous configuration of ignition device 27 according to the present invention, in which laser pulse 24 generated by laser device 26 is scattered, at least partially, at combustion chamber window 50 and/or at deposits 51 present on a surface of combustion chamber window 50 facing combustion chamber 14. The resulting scattered light or scattered radiation is partially reflected back into housing 26′ of laser device 26. A first portion of the scattered light is indicated by arrow 241 in FIG. 3b, and is detected by detector 241′ situated in the region of focusing lens 49. A further portion of the scattered light may also first pass through focusing lens 49 before it is detected by an appropriately positioned detector, not illustrated in FIG. 3b. This portion of the scattered light is indicated by arrow 242 in FIG. 3b.

The evaluation according to the present invention of the radiated power of scattered light 241, 242 advantageously provides very precise information concerning deposits 51, and thus the soiling state of the combustion chamber window. The intensity of scattered light 241, 242 increases with increasing thickness of deposits 51 on combustion chamber window 50. According to the present invention, the intensity of scattered light 241, 242 is advantageously correlated with an intensity of emitted laser pulse 24 which in the region of combustion chamber window 50 is at least partially scattered by deposits 51, thus forming scattered light 241, 242.

In addition to the locally situated detector 241′ illustrated in FIG. 3b, according to the present invention an optical fiber, not illustrated in FIG. 3b, may also advantageously be provided which conducts scattered light 241, 242 to a remotely situated detector (not shown). Optical fiber device 28 (FIG. 2), which is used primarily for supplying pumped light 60, may also be used in an extremely advantageous manner to transmit scattered light 241, 242 from laser device 26 to a remotely situated detector. For this purpose, optical fiber device 28 may have multiple individual optical fibers, for example, only a few of,which are used for transmitting pumped light 60, and the rest of which may be used for transmitting scattered light 241, 242.

To improve a signal-to-noise ratio, a focusing lens (not shown in FIG. 3b) may also advantageously be provided which bundles scattered light 241, 242 on detector 241′ or optionally on a corresponding optical fiber.

According to the present invention, as described above laser pulse 24 provided as an ignition pulse may at the same time advantageously be used as test radiation in a manner of speaking, which produces scattered light 241, 242 in interaction with deposits 51.

Alternatively, by use of laser device 26 a separate laser pulse may be generated, which on account of a lower pulse energy does not result in generation of an ignition plasma 22a, but likewise produces scattered radiation 241, 242 which may be evaluated according to the present invention.

The test radiation may also be supplied to combustion chamber window 50 via a separate optical fiber device (not shown) which may also be used, for example, to transmit scattered light 241, 242 to be evaluated to a remotely situated evaluation device. Pumped light 60 may also be used as test radiation.

It is also possible to provide a separate light source (not shown) for generating the test radiation.

In a further very advantageous variant of the present invention, combustion chamber window 50 is acted upon by test radiation in such a way that deposits 51 present on the surface of combustion chamber window 50 are at least partially converted to a plasma 51a, as indicated in the present case in FIG. 3c. The radiation emitted by plasma 51a may advantageously also be supplied to an evaluation device according to the present invention. Due to the characteristic emission spectra of the components of deposits 51, in this method variant detailed information is obtained concerning the type of deposits 51 and the degree of soiling. Spectral analysis of the received radiation is thus particularly preferably carried out.

A high-energy laser pulse 24 is preferably used as test radiation to generate plasma 51a. Such high-energy laser pulses 24 may at the same time also be advantageously used for cleaning combustion chamber window 50.

In the configuration according to FIG. 3c, radiation 243, 244 emitted by plasma 51a is analyzed similarly to the variant of the present invention according to FIG. 3b.

The wavelengths of emission spectra of plasma 51a are markedly different from the wavelengths of pumped light 60 typically used (FIG. 2) and of ignition plasma 22a, and therefore may be easily separated from same. The radiation emitted by plasma 51a, similarly to radiation 240 according to FIG. 3a, may also pass through laser device 26 and may be supplied to a detector in a suitable manner.

In a further very advantageous variant of the present invention, it is provided that combustion chamber 14 is acted upon by test radiation 24, preferably through combustion chamber window 50, as illustrated in FIG. 3d. The test radiation once again may preferably be a laser pulse 24 generated by laser device 26. According to the present invention, test radiation is reflected on a component of combustion chamber 14, in particular on a piston crown 16a of a piston 16 associated with combustion chamber 14 (FIG. 1). Reflected radiation component 245 passes from piston crown 16a, as indicated by the dashed-line arrow shown in FIG. 3d, through laser device 26, and is analyzed similarly to the configuration according to FIG. 3a. Reflected radiation component 245 may also be detected in the same manner as radiation 243, 244, similarly to FIG. 3c.

Separation of reflected radiation component 245 from other radiation components may be facilitated according to the present invention by the fact that a length of the optical path of test radiation 24 and/or of reflected component 245 is enlarged, for example by folding the beam path or providing an optical retarder (not shown).

Alternatively or additionally, for this purpose transformation of the wavelength of test radiation 24 may also be provided, which may be achieved, for example, by applying a fluorescent layer to piston crown 16a.

To avoid unintentional ignition, in the presently described method variant test radiation 24 preferably has a relatively low intensity.

A further very advantageous configuration of the ignition device according to the present invention is shown in FIG. 3e. A separate test radiation generator 30′ which is situated at a distance from laser device 26 generates test radiation which is supplied to laser device 26 via a separate optical fiber device 29a. The test radiation is focused on a point in the region of combustion chamber window 50, using a focusing lens 29a′ situated downstream from optical fiber device 29a. A radiation component of the test radiation which is a function of the degree of soiling of combustion chamber window 50 is reflected, in the region of surface 50a of combustion chamber window 50 on the combustion chamber side, on further focusing lens 29b′ which bundles the received radiation into a further optical fiber device 29b in order to conduct the radiation to remotely situated detector 241′.

For the evaluation, the intensity of reflected radiation 246 is preferably correlated with the intensity of the radiation emitted by focusing lens 29a′. This relationship is advantageously a function of the degree of soiling of combustion chamber window 50, but not of influences from combustion chamber 14 or laser device 26.

As illustrated, the test radiation may be emitted at a specifiable angle relative to a surface normal to combustion chamber window 50, it also being possible for the test radiation to first pass through primary focusing lens 49 of laser device 26, or directly from further focusing lens 29a′ to combustion chamber window 50.

In the present case, focusing lenses 29a′, 29b′ focus the inputs and outputs of optical fibers 29a, 29b on combustion chamber window 50, thus increasing the signal-to-noise ratio. Alternatively, focusing lenses 29a′, 29b′ may be omitted. In particular, components 29b, 29b′ may be omitted when a corresponding detector is provided directly at the location of focusing lens 29b′ illustrated in FIG. 3e.

According to the present invention a polarization dependency of reflected radiation 246, in particular for surface analysis, may also be evaluated.

Test radiation generator 30′ may advantageously be a component of pumped light source 30.

In the variant of the present invention illustrated in FIG. 3e, the test radiation may also advantageously be laterally injected into combustion chamber window 50, so that in FIG. 3e the test radiation propagates in combustion chamber window 50, for example from bottom to top, via multiple total reflections at the left and right surfaces, shown in FIG. 3e, of combustion chamber window 50, and at an upper end, shown in FIG. 3e, is extracted from combustion chamber window 50 for a corresponding evaluation. The corresponding reflections of the test radiation in combustion chamber window 50 are likewise a function of soiling 51 thereof.

In the variant of the present invention illustrated in FIG. 3f, it is provided that test radiation 246, in contrast to FIG. 3e, is emitted essentially perpendicularly to combustion chamber window 50. A reflected radiation component of test radiation 246 is advantageously separated from other radiation components using propagation time filtering. This ensures that only the radiation components of test radiation 246 of interest according to the present invention which are reflected on combustion chamber window 50 are evaluated, and not, for example, other radiation components reflected on objects other than combustion chamber window 50.

Propagation time filtering is facilitated by folding the beam path in a manner known per se. For this purpose, as illustrated in FIG. 3f multiple reflector systems (not illustrated) are provided. Alternatively or additionally, the optical wavelength may be further lengthened, for example by introducing an optical retarder 247 which, for example, is an element having a relatively high index of refraction (n>1).

The same as for the variants of the present invention described above, also for the configuration according to FIG. 3f, laser pulse 24 provided for ignition or a separate laser pulse may be used as test radiation 246.

The components and retarder 247 which achieve the folded beam path are advantageously integrated, together with laser device 26, into a common housing 26′ which preferably is housing 26′ associated with laser device 26.

In the variant of the present invention illustrated in FIG. 3g, the radiation emission of a location P situated outside ignition plasma 22a is detected in combustion chamber 14. For this purpose, focusing lens 29c′ and optical fiber device 29c associated therewith are provided which supply the radiation of interest from location P to a detector, not described in greater detail. Since in this variant of the present invention as well, combustion chamber window 50 is contained in the beam path from location P to focusing lens 29c′, evaluation of the radiation of interest once again allows a degree of soiling of combustion chamber window 50 to be deduced.

In one particularly simple passive design, only the radiation from a flame core surrounding ignition plasma 22a is detected, while in an active design it is also possible to act upon location P by test radiation, for example pumped light 60.

The optical signal obtained in the configuration according to FIG. 3g may also advantageously be used to characterize the flame core in the region of location P.

Using a correspondingly high time resolution in the analysis of the radiation originating from the flame core, it is possible to ascertain, for example, the propagation speed and magnitude of the flame core. An optional spectral analysis advantageously provides characteristic information concerning the nature and temperature of the flame core at location P and concerning the mixture composition.

In general, cleaning of combustion chamber window 50 or also maintenance of ignition device 27, for example, may be prompted for as a function of the optical signal obtained according to the present invention. For this purpose a corresponding error entry is applied to an error memory of control unit 32 (FIG. 1) which controls ignition device 27, for example as soon as the soiling of combustion chamber window 50 exceeds a specifiable threshold value.

If ignition device 27 has a laser light source 26, control unit 32 may also directly bring about cleaning of combustion chamber window 50 by being acted upon using high-energy laser pulses 24.

However, such self-cleaning is carried out to spare laser device 26 and in particular pumped light source 30 only when a correspondingly high degree of soiling is present.

According to the present invention, repeatedly and quickly reaching a high degree of soiling may be interpreted to mean that unsuitable operating materials are being used for internal combustion engine 10. In this case as well, an error entry may be applied or new maintenance may be prompted for.

On the basis of the emission spectra of ignition plasma 22a, of plasma 51a formed from deposits 51, and of the flame core (see location P), the use in particular of unsuitable operating materials may also be deduced, it being possible once again to apply a corresponding error entry or prompt for new maintenance.

The principle according to the present invention may also be advantageously provided for ignition devices without laser ignition.

Furthermore, the ignition device according to the present invention may also be operated together with stationary engines. In general, any ignition device or internal combustion engine in which a combustion chamber window 50 is present, and optionally for which a test radiation source may be provided, may be evaluated according to the present invention.

1-16. (canceled)

17. A method for operating an ignition device in an internal combustion engine, having a combustion chamber window for optically connecting the ignition device to a combustion chamber, comprising: detecting an optical signal in a region of the combustion chamber window and evaluating the optical signal to deduce a state of the combustion chamber window.

18. The method as recited in claim 17, wherein the ignition device has a laser device via which a laser pulse is emitted through the combustion chamber window and into the combustion chamber.

19. The method as recited in claim 17, wherein radiation emitted by at least one of an ignition plasma and a flame core in the combustion chamber is evaluated as an optical signal.

20. The method as recited in claim 19, wherein the optical signal is also used to characterize the flame core.

21. The method as recited in claim 17, wherein radiation scattered on at least one of the combustion chamber window and on deposits present on a surface of the combustion chamber window is evaluated as an optical signal.

22. The method as recited in claim 17, wherein the combustion chamber window is acted upon by test radiation to result in scattered radiation which is evaluated.

23. The method as recited in claim 22, wherein the test radiation is selected in such a way that deposits present on a surface of the combustion chamber window are at least partially converted into a plasma, and a radiation emitted by the plasma is evaluated as an optical signal.

24. The method as recited in claim 17, wherein the combustion chamber is acted upon by test radiation through the combustion chamber window, and a radiation component of the test radiation reflected on a piston crown of a piston associated with the combustion chamber is evaluated as an optical signal.

25. The method as recited in claim 17, wherein the combustion chamber window is acted upon by test radiation, and a radiation component of the test radiation reflected on the combustion chamber window is evaluated as an optical signal.

26. The method as recited in claim 25, wherein the test radiation is emitted essentially perpendicularly onto the combustion chamber window.

27. The method as recited in claim 26, wherein the radiation component of the test radiation reflected on the combustion chamber window is separated from radiation components of the test radiation reflected from objects other than the combustion chamber window using propagation time filtering.

28. The method as recited in claim 17, wherein at least one of maintenance of the ignition device and cleaning of the combustion chamber window is prompted for as a function of the evaluation of the optical signal.

29. The method as recited in claim 17, wherein cleaning of the combustion chamber window is carried out as a function of the evaluation of the optical signal by acting upon the combustion chamber window using laser pulses.

30. The method as recited in claim 17, wherein the use of unsuitable operating lubricants for a cylinder associated with the combustion chamber is deduced as a function of the evaluation of the optical signal.

31. An ignition device for an internal combustion engine, comprising a combustion chamber window for optically connecting the ignition device to a combustion chamber, wherein an optical signal which may be detected in the region of the combustion chamber window is able to be evaluated to deduce a state of the combustion chamber window.

32. The ignition device as recited in claim 31, wherein the ignition device is designed for carrying out the method as recited in claim 17.
